(19) United States
(12) Patent Application Publication
(10) Pub. No.: US 2005/0024852 A1
(43) Pub. Date: Feb. 3, 2005

(54) Letter flashing system for footwear and personal articles

(76) Inventors: Wai Kai Wong, Kowloon (HK); Lai Cheong Mak, Kowloon (HK)

Correspondence Address: BRINKS HOFER GILSON & LIONE, P.O. BOX 10395, CHICAGO, IL, 60610, US

(21) Appl. No.: 10/631,881

(22) Filed: Jul. 31, 2003

(51) Int. Cl. F21V 21/08

(52) U.S. Cl. 362/103

(57) ABSTRACT

A flashing light system uses a controller or controlling integrated circuit to flash one or more series of lamps, such as LEDs. The lamps or LEDs are arranged to form a predetermined pattern, such as a letter or other alphanumeric character. Random patterns may also be generated and used. The LEDs may also be arranged to highlight or display an illustration, a logo or other character.

### TECHNICAL FIELD

The present invention relates generally to footwear with flashing light systems. More particularly, the flashing light systems may be controlled in such a manner that even with systems having only a few LEDs, the system appears to flash a message.

### BACKGROUND

Lighting systems have been incorporated into footwear, generating distinctive flashing lights when a person wearing the footwear walks or runs. These systems generally have an inertia switch, so that when a runner's heel strikes the pavement, the switch activates the flashing light system, triggering a response by at least one circuit that typically includes a power source and a means for powering and controlling the lights. The resulting light flashes are useful in identifying the runner, or at least the presence of a runner, because of the easy-to-see nature of the flashing lights. Thus, the systems may contribute to the fun of exercising while adding a safety feature as well.

These lighting systems, however, suffer from a number of deficiencies. The flashing of lights may be made more interesting to passers-by if there is a pattern in the flashing lights. Some flashing or intermittent light systems have only a single light. While a single flashing light makes the user more visible, there is no provision for varying or making the pattern interesting. Other systems may also use only a single lamp or LED, but then also use optical fibers or a transparent/translucent plate to flash a name or other message.

It would be desirable to have a interesting display, such as a message or slogan using several LEDs in flashing footwear, an article of clothing or other personal accessory. Some flashing light systems are able to display a logo or slogan, but the display is still relatively static. These systems only display a pre-manufactured logo or name using transparent or translucent plastic for backlighting by one or more LEDs or optical fibers carrying light from one or more LEDs. Such a display cannot be easily changed except by manufacturing a new display. What is needed is a way to display a message or greeting with flashing light systems that does not require a pre-manufactured, static display. The present invention is directed at correcting these deficiencies in the prior art.

### BRIEF SUMMARY

One aspect of the invention is a flashing light system. The flashing light system comprises a controller, a power source connected to the controller, and a switch connected to at least one of the power source and the controller. The system also comprises a plurality of lamps connected to the controller, wherein the switch and the controller activate the plurality of lamps to display an alphanumeric character by quickly flashing the lamps in a sequence.

Another aspect of the invention is a method of displaying a message. The method comprises wearing an item selected from the group consisting of footwear, an article of clothing, or a personal accessory, the item further comprising a flashing light system. The flashing light system comprises a controller, a power source connected to the controller, a switch connected to at least one of the power source and the controller, and a plurality of lamps connected to the controller, wherein the switch and the controller activate the plurality of lamps to display an alphanumeric character by quickly flashing the lamps in a sequence. The method then comprises activating the flashing light system and displaying the message.

Another aspect of the invention is a flashing light system, the flashing light system comprising a controller, a power source connected to the controller, and a switch connected to at least one of the power source and the controller. The system also comprises a first plurality of LEDs connected to the controller, wherein the switch and the controller activate the first plurality of LEDs to display an alphanumeric character by flashing the LEDs in a sequence, and a second plurality of LEDs connected to the controller, wherein the switch and the controller activate the second plurality of LEDs to display at least one pattern.

Another aspect of the invention is a method of displaying a message. The method comprises furnishing a flashing light system in footwear, an article of clothing, or a personal accessory, the flashing light system further comprising a controller, a power source connected to the controller, a switch connected to at least one of the power source and the controller, and a plurality of lamps connected to the controller. The method then comprises activating the flashing light system and displaying a message by quickly flashing the lamps in a sequence, wherein the lamps flash at least two alphanumeric characters in sequence to form the message.

Another aspect of the invention is a flashing light system. The flashing light system comprises a controller, a power source connected to the controller, and an inertia switch connected to at least one of the power source and the controller. The flashing light system also comprises a first and a second plurality of lamps connected to the controller, wherein when the inertia switch closes at a low frequency the controller activates the first plurality of lamps, and when the inertia switch closes at a high frequency, the controller activates the second plurality of lamps.

Another aspect of the invention is a flashing light system comprising a controller, a power source connected to the controller, and an inertia switch connected to at least one of the power source and the controller. The flashing light system also comprises a plurality of lamps connected to the controller, wherein when the inertia switch closes at a low frequency the controller activates the plurality of lamps to display a first pattern, and when the inertia switch closes at a higher frequency the controller activates the plurality of lamps to display a second pattern.

Other systems, methods, features, and advantages of the invention will be or will become apparent to one skilled in the art upon examination of the following figures and detailed description. All such additional systems, methods, features, and advantages are intended to be included within this description, within the scope of the invention, and protected by the accompanying claims.

### BRIEF DESCRIPTION OF THE DRAWINGS

FIG. 1 is a first embodiment of the invention;

FIGS. 2a-2c are more detailed views of portions of the embodiment of FIG. 1;

FIG. 3 is a second embodiment of the invention;

FIG. 4 is a third embodiment of the invention;

FIG. 5 is a fourth embodiment of the invention;

FIG. 6 is a fifth embodiment of the invention;

FIG. 7 is a cross-sectional view of the fifth embodiment;

FIGS. 8a-8c are schematic diagrams of fade-in/fade-out circuits;

FIG. 9 is a schematic diagram of a fade-in/fade-out circuit;

FIG. 10 is a schematic diagram of a circuit with more than one power supply and lamps capable of using more than one power supply; and

FIG. 11 is a schematic diagram of a circuit with a battery charger.

### DETAILED DESCRIPTION OF THE DRAWINGS AND THE PRESENTLY PREFERRED EMBODIMENTS

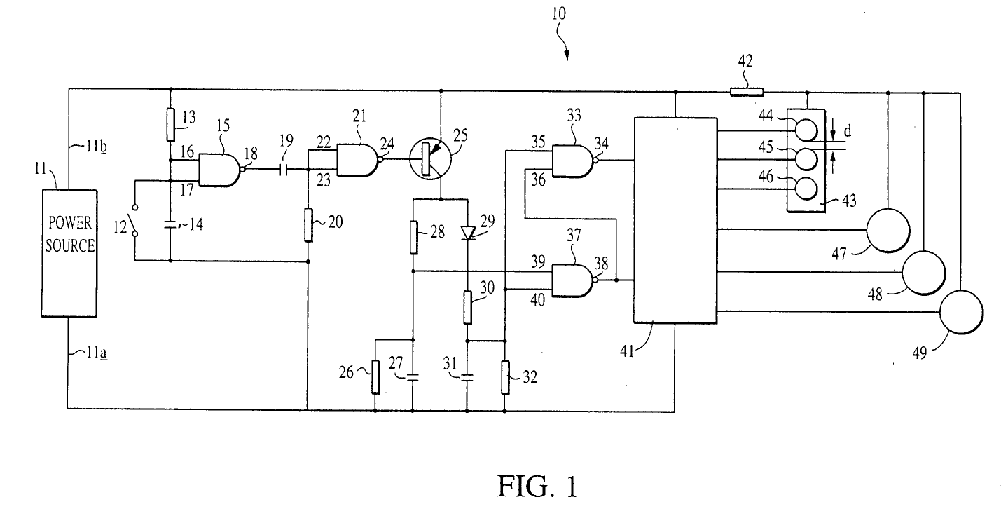

A first embodiment of a flashing light system according to the present invention is presented in FIG. 1. The flashing light system 10 comprises a power supply or battery 1, with a positive rail 11b and a negative rail or ground 11a. The system also has an inertia switch 12, and a resistor 13 and a capacitor 14 connected to input terminals 16, 17 of NAND gate 15. The output 18 of NAND gate 15 is further connected to a second capacitor 19 and a resistor 20 to inputs 22, 23 of a second NAND gate 21. The output 24 of NAND gate 21 is connected to a base of a control transistor 25. The emitter of control transistor 25 connects to power supply positive rail 11b and the collector connects to a negative rail or ground 11a through a series of other components.

The collector of transistor 25 connects to ground via a resistor-capacitor combination, resistor 26, capacitor 27, and resistor 28. The common-node between resistors 26, 28 also connects to input 39 of additional NAND gate 37. The other input 40 of NAND gate 37 connects to the ground or negative rail through resistor 32. The collector of transistor 25 connects to ground through diode 29, resistors 30 and 32, and capacitor 31. NAND gate 33 includes inputs 35, 36 from the output 38 of NAND circuit 37 and resistor 32, as shown. The outputs of NAND circuits 33 and 37 are then routed to controller 41.

NAND gates 21, 33, 37 and controller 41 display patterns or alphanumeric characters using display 43 and a first plurality of LEDs 44-46, and also a second plurality of LEDs 47, 48, 49. A user activates inertia switch 12 of the flashing light system 10 which is embedded into footwear or another item, such as an accessory or an article of clothing. The user may, for instance, be walking, in which case the inertia switch will be tripped slowly, at a low frequency, such as tripping the inertia switch at a rate of less than 3 times per second or 3 Hz. With switch 12 open, resistor 13 will pull inputs 16, 17 of NAND gate 15 high, so its output 18 is low. When switch 12 closes, both inputs 16, 17 are grounded, so output 18 goes high. Inputs 22, 23 to NAND circuit 21 will now be HIGH, and output 24 will change to LOW. Transistor 25 will conduct, charging capacitors 27 and 31. Capacitor 27 charges through resistor 28 and discharges through resistor 26. Capacitor 31 charges through diode 29 and resistor 30. If resistor 28 has a larger resistance than resistors, 26, 30, the capacitor 27 will not charge to as high a voltage as capacitor 31. Capacitor 31 will charge to a higher level, and inputs 35, 40 of NAND gates 33, 37 will then go to HIGH while input 39 stays LOW. Under these conditions, output 38 of NAND circuit 37 will be HIGH and output 34 of NAND circuit 33 will be LOW. The inputs to the controller will thus be one LOW and one HIGH. The controller 41 may be programmed to display a particular pattern when the outputs of NAND circuits 33, 37 are LOW, HIGH. The controller may also be programmed to flash a particular sequence of lamps when the motion switch is tripped at a rate of less than 3 Hz.

Alternatively, the user of footwear with a flashing light system may walk fast or run, in which case the inertia switch may be tripped or activated at a higher frequency, such as tripping the inertia switch about three times every second or faster. With this fast frequency, transistor 25 may continue to conduct longer than it did with a slow frequency. In this case, capacitor 27 may charge to a higher voltage, as does capacitor 31. With capacitor 27 at a higher voltage, input 39 to NAND circuit 37 may also go high. With inputs 39, 40 to NAND circuit 37 both HIGH, output 38 goes LOW and output terminal 34 of NAND circuit 33 goes HIGH, the opposite of the previous low-frequency example. The outputs of NAND circuits 33, 37 are now HIGH, LOW, and the controller 41 may be programmed to display or enable a predetermined pattern of flashing lights different from the pattern that was programmed with the low-frequency tripping.

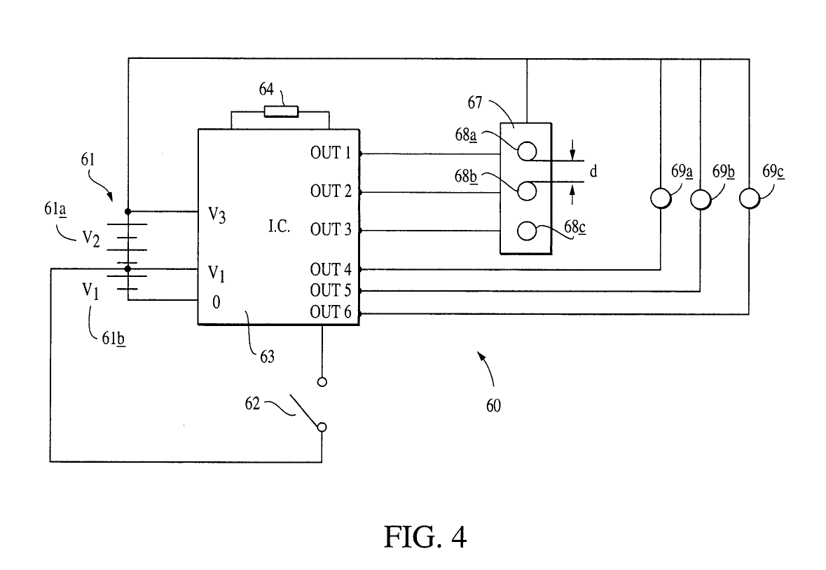

The controller may be any of a number of integrated circuits suitable for controlling the flashing of the lamps or LEDs in the system. One example of such an integrated circuit, manufactured with CMOS techniques for one-time programmable, read-only memory, is Model No. EM78P153S, made by EMC Corp., Taipei, Taiwan. The controller may be an integrated circuit, such as MC14017BCP, CD4107AF, made by many manufacturers, or may be a custom or application specific integrated circuit, or may be a CMOS circuit, such as a CMOS 8560 circuit. Other examples include M1320 and M1389 RC integrated circuits are made by MOSdesign Semiconductor Corp., Taipei, Taiwan. Custom circuits or application specific circuits, such as circuits incorporating the design of FIG. 1 or FIG. 4 may also be used.

Controller 41 may be programmed to flash the LEDs or other lamps in one pattern for low-frequency tripping and in another pattern for higher-frequency tripping. For instance, LEDs 47, 48, 49 may be arranged in a line on a side of a shoe or arranged clockwise on a belt of a user. The pattern which is programmed for low frequency tripping may be 47, 48, 49, 47, 48, 49, and then stop, i.e., a forward pattern of lights or LEDs. The pattern for high frequency tripping may be 49, 48, 47, 49, 48, 47, and then stop, i.e. a backwards pattern. Other patterns may include random on/off switching, or fade-in/fade-out sequences of lights or LEDs. LEDs 47, 48, 49 may be the same color or may be different colors, such as red, yellow, green, or other colors.

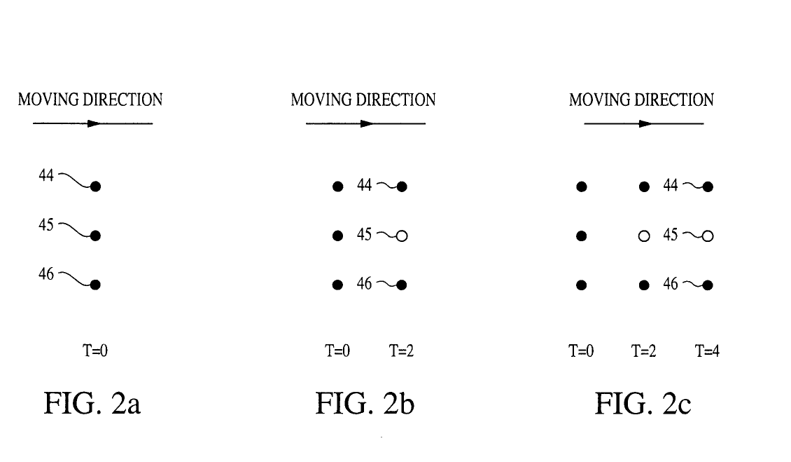

Controller 41 may also use display 43 with three LEDs 44, 45, 46, to display a message. FIGS. 2a-2c depict a method of displaying a message using only a few LEDs with very fast sequencing and flashing. Display 43 has three LEDs 44, 45, 46 in a column or vertical alignment. FIG. 2a shows the three LEDs in a first instant of time or moment, t=0, with all three LEDs lit. FIG. 2b shows the three LEDs in a first and a second instant of time, with LEDs 44, 46 lit in the second instant, t=2, but LED 45 not lit. Finally, FIG. 2c shows the display in first, second and third instants of time. In the third instant, t=4, LEDs 44, 46 are lit but LED 45 is not lit. Each instant of time may be one millisecond long, or may be several milliseconds long, such as 1-4 ms. The instants of flashing may be separated by short time intervals, such as about 1-2 ms. The overall effect is to display the letter “C”. After a brief interval, longer than the intervals used to form the letter “C”, a second letter may be “formed” by this technique. Several letters may thus be used to form a word or more than one word, thus spelling out a simple message for a first pattern using display 43. An example is “CEE-YA” or “CEE-YOU” to be displayed.

A different message may be spelled out when the NAND gates 33, 37 change their outputs, for instance from LOW, HIGH to HIGH, LOW. The second message may be a different sequence, such as “HI!” The messages are preferably simple and short, such as “HI!”, or “BYE!”, and the like. The letters or parts of letter may also be combined with special effects, such as a fade-in or a fade-out circuit, or fade-in and fade-out circuits on the LEDs, portraying a letter or a part of a letter for a longer or shorter period of time.

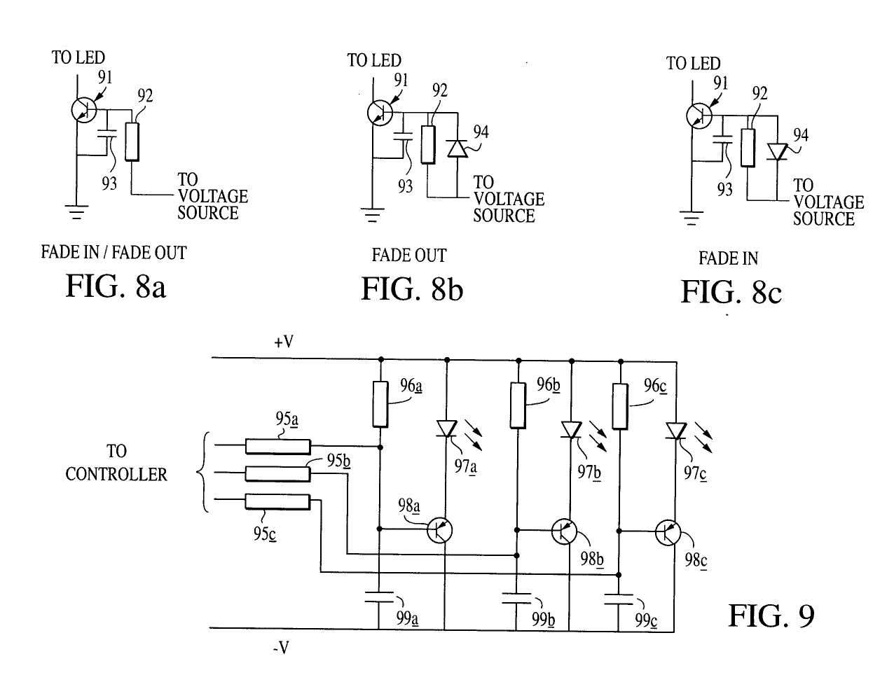

Fade-in and fade out circuits are depicted in FIGS. 8a-8c and FIG. 9. FIG. 8a depicts a fade-in/fade out circuit which may be used to connect an LED (not shown) to a voltage source and to ground. In FIG. 8a, transistor 91 will only turn on when capacitor 93 is charged through resistor 92. However, in order for capacitor 93 to charge, power must charge slowly through resistor 92. Therefore, when the transistor is first turned on, it will turn on slowly as capacitor 93 charges slowly to the full voltage of the voltage source. When the voltage source is then disconnected, transistor 91 will still conduct until capacitor 93 is discharged. However, capacitor 91 can only discharge through resistor 92, which will take some period of time. Therefore, it will take time and voltage decay before transistor 91 in FIG. 8a ceases to conduct. Thus, the circuit of FIG. 8a will have a “fade-out” effect as well as a “fade-in” effect.

In FIG. 8b, the circuit depicted will have a fade-out effect when connected with an LED. Transistor 91 will conduct when capacitor 93 is charged through diode 94 connected to a voltage source. Because diode 93 is connected directly between capacitor 92 and the voltage source, the capacitor will charge quickly, and there will be no “fade-in” effect. However, when the voltage source is disconnected, transistor 91 will continue to conduct until capacitor 93 discharges though resistor 92. Because this will take some time, this circuit will show a “fade-out” effect.

In FIG. 8c, the circuit shown with diode 94 reversed, relative to the circuit of FIG. 8b, will have a fade-in effect. With diode 94 reversed, power is applied to the gate of the transistor through resistor 92, charging capacitor 93 slowly. Thus, there will be a “fade-in” effect, as the power gradually turns on transistor 91. When power is removed, however, capacitor 93 will discharge quickly through diode 94, which is installed for reverse current flow. Thus, there will be a “fade-in” effect, but no “fade-out” effect in the circuit of FIG. 8c. The fade-in and fade-out effect may be used to vary the patterns, such as beginning with a fade-in, or ending with a fade-out, or using either between words or letters of a short message or slogan.

FIG. 9 depicts another circuit in which fade-in and fade-out sequences are enabled. The circuit includes a positive voltage rail and a negative voltage rail or ground. There are three LEDs 97a, 97b and 97c, which may be arranged into a vertical display as discussed previously. Each LED is connected between the voltage rails via a transistor 98a, 98b, 98c. The transistors conduct when their gates bias the transistors to conduct. Each transistor gate is connected to the controller (not shown) via resistors 95a, 95b, 95c. The gates are also connected to the positive voltage rail by current-limiting resistors 96a, 96b, 96c, and to the negative voltage rail or ground by capacitors 99a, 99b, 99c. There will be a fade-in effect for each LED 97a, 97b, 97c. When the controller enables the negative voltage rail, capacitors 99a, 99b, 99c will discharge slowly through resistors 96a, 96b, 96c, and there will be a fade-in effect as the capacitors slowly come up to voltage and the transistors gradually conduct more and more voltage to the LEDs. When the controller changes to high voltage (positive), the capacitors must charge through resistors 95a, 95b, 95c. There will be a fade-out effect as the capacitors slowly increase in voltage and the voltage increase across the transistors slowly increases as the transistors cease to conduct. Many other embodiments of fade-in and fade-out circuits may also be used with LEDs.

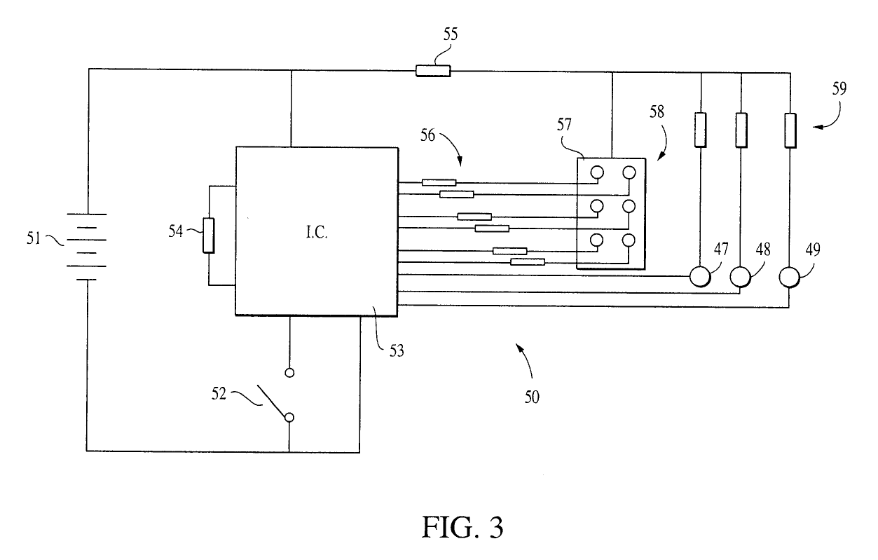

Applications of circuits for flashing messages are not limited to displays having three LEDs. For instance, instead of a display having a single column or vertical display of three LEDs, the flashing light system may have two columns with three LEDs each. FIG. 3 depicts a simplified circuit diagram for a flashing light system 50 with a display 57 having two columns of three LEDs each. The LEDs may be different color combinations to make the resulting letter more colorful. The system includes a power supply 51 and an inertia switch 52, as well as an oscillator resistor 54. An integrated circuit 53 is connected to supply 51 and switch 52, as well as display 57 and more LEDs 47-49. Integrated circuit 53 may be a custom-made or application specific integrated circuit, or may be an off-the-shelf item. One example of such an integrated circuit manufactured with CMOS techniques for one-time programmable, read-only memory is Model No. EM78P153S, made by EMC Corp., Taipei, Taiwan. The power supply 51 is connected to display 57 through a current-limiting resistor 55.

Display 57 comprises 6 LEDs 58, arranged as shown in two columns with three rows. In one embodiment, the LEDs are preferably separated by not more than 2 mm vertically and about 2-3 mm horizontally. Separation distance means the distance between the closest points on the perimeters of the LEDs in question. Flashing light system 50 also includes a second plurality of LEDs 47, 48, and 49, and current-limiting resistors 59. LEDs 47-49 are also connected to power supply 51 through current-limiting resistor 55. LEDs 58 in display 57 are connected to the controller through control resistors 56 which may also be current-limiting resistors. To illuminate display 57, LEDs 58 or LEDs 47-49, the integrated circuit includes circuits, such as those depicted in FIG. 1, to gauge the frequency of tripping of inertia switch 52 and to activate the sequences that are programmed into the controller. Controller 53 may include NAND gates such as those depicted in FIG. 1 or may include other circuits that will allow the system to alternate between programmed sequences.

Flashing light systems according to the present invention may also include more than one power supply, so that the lights may vary in their intensity, adding interest to the display of lights. FIG. 4 depicts a flashing light system 60 with a power supply 61 having two batteries, 61a, 61b, connected in series. In this embodiment, the batteries may be two 3V batteries, or they may be a 3V battery and a 1.5 V battery, or any other suitable combination of battery voltages. The combined output of V1 and V2 may be V3 and may be available to the LEDs and to controller 63. The anodes of batteries 61a, 61b are connected to controller 63. The flashing light system also has an inertia switch 62 and an oscillator resistor 64. The display 67 may include a first plurality of LEDs 68a, 68b, 68c, as discussed above for an LED display, each LED separated by at least 2 mm.

Flashing light system 60 may also include a second plurality of LEDs, 69a, 69b, 69c. The LEDs in the second plurality may be of different colors, such as blue, red and pink LEDs, or they may be the same color. At least one of LEDs 68a, 68b, 68c, 69a, 69b, 69c is connected internally within controller 63 so that it can receive more than one voltage, in sequence, such as a higher voltage and a lower voltage, so that the LED may flash brighter and dimmer in sequence. The flashing of the LEDs is controlled by the outputs of controller 72.

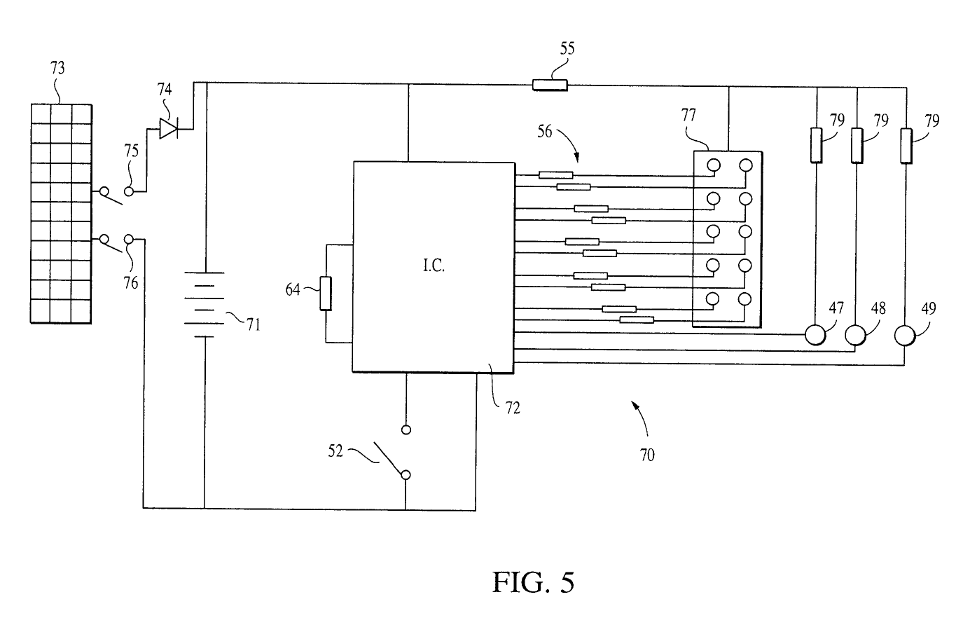

Another embodiment of the invention is a flashing light system as depicted in FIG. 5. Flashing light system 70 includes a power supply 71 with positive and negative rails. There is also an inertia switch 52, an integrated circuit controller 72, and a control resistor 64. There is a battery charger 73 in the form of a solar panel and circuitry (not shown) for converting solar energy to electric power of the proper current and voltage for the power supply 71. The battery charger is connectable through connecters 75, 76, and protective diode 74, to the power supply 71 and controller 72. In this embodiment, the flashing light system also includes a display 77 of ten LEDs in two columns of five LEDs, each connected to the power supply through current limiting resistor 55 and to the controller though resistors 56. The alphanumeric characters discussed above may also be displayed with this circuit. The larger display, ten LEDs rather than three, allow a greater degree of freedom in adapting the display to sequences of flashing letters, numbers, or other characters. There may also be additional LEDs 47, 48, 49, connected to controller 72 though current limiting resistor 55 and resistors 79.

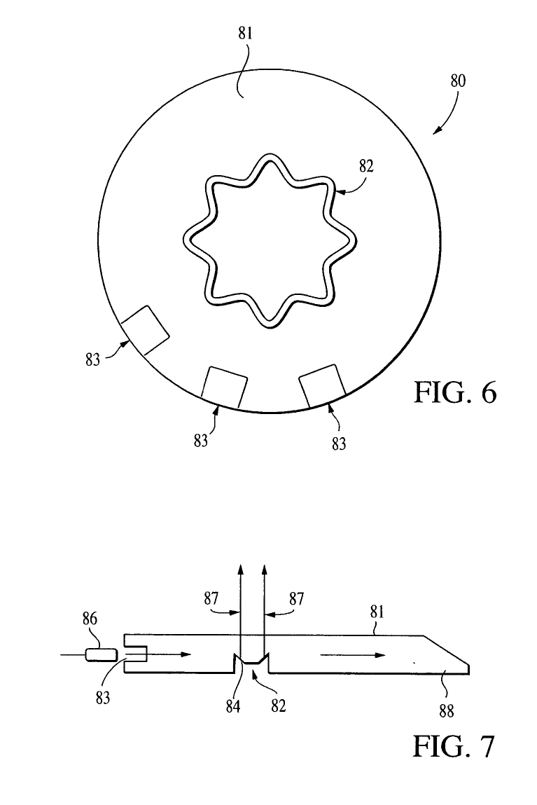

The displays from the flashing light systems of the present invention are not limited to letters or numbers. FIGS. 6 and 7 depict another way to attract attention from passers-by using flashing light systems. The extra, non-display LEDs in FIGS. 1 and 3-5 may be used in a different type of display. For example, three LEDs may be inserted into a display in the manner shown in FIG. 6. A decorative item 80 is formed from a transparent plastic disc or wheel 81 with a pattern 82 imprinted or embossed on the disc. The pattern may be a flower as shown, or may be a logo or symbol, or other device which a user may wish to display or call attention to. In one display according to the present invention, the disc 81 has a plurality of cavities or entrances 83 molded into the side of the disc.

As further shown in FIG. 7, an LED 86 is inserted into each cavity 83. Light 87 then travels from the LED through the transparent plastic and may be reflected or refracted outward from the center of the disc when light 87 reaches the pattern 82 in the center of the disc. The pattern preferably is molded into the bottom surface of the disc, with at least one sloped surface 84 so that light 87 will be refracted or reflected upward and out through pattern 82. Disc 81 may be mounted to footwear, a personal accessory, a hat, a hairpiece, an article of clothing or other item by sewing or otherwise mounting the disc. In the embodiment shown in FIG. 7, at least part of the edge of the disc has a reduced thickness 88 in order to make the disc easier to sew onto a shoe, a boot, an article of clothing, a backpack, or other personal accessory. Of course, the shape need not be a disc, but may be any other convenient or desired shape, such as a square, a rectangle, or other shape.

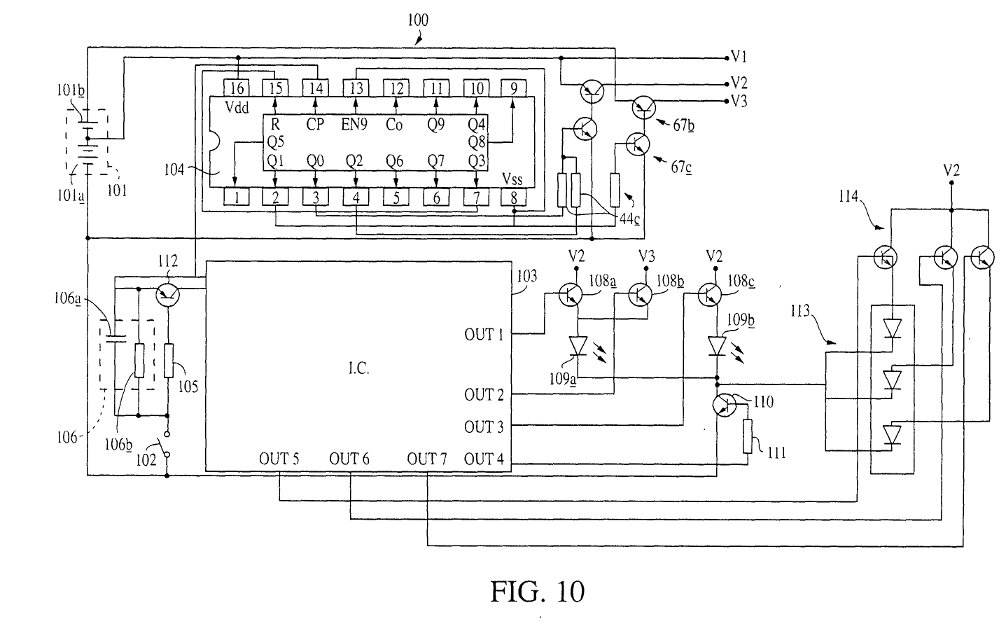

Another embodiment of a flashing light system with power selection levels is the system 100 for flashing lights depicted in FIG. 10. The system 100 depicted in FIG. 10 includes power supply 101, controller 103, decade counter 104, control circuit 106, LEDs 109a, 109b, and 113, and control transistors 67b, 67c, and 114, and secondary and primary control transistors 110 and 112.

In this system, power supply 101 comprises two batteries 101a and 101b, which may be 3V and 1.5V batteries. Examples of a 3V battery include a CR2032 and a CR2450 battery. Examples of a 1.5V battery include an AG13 battery (L1154). 3 volt (3 V) power from power supply 101 is routed to the decade counter 104, to pin 16 for power and control, and is also routed to the pin labeled V1. 3 volt (3V) power is also routed to the emitter of one voltage supply transistor 67b, to the collector of that transistor as “V2.” V2 will thus be at 3 volts, less a small voltage drop across transistor 67b. 4.5V power is routed from power supply 101 to a second voltage supply transistor 107b, producing voltage “V3” at the collector of that transistor. Other voltages may be used as desired.

The remainder of the circuit includes an integrated circuit controller 103, connected to decade counter 104 as shown, and also connected to secondary control transistors or secondary gates 108a, 108b and 108c, as well as LEDs 109a and 109b, and secondary control transistor 110 and resistor 111. The system 100 is controlled by outputs 1-7 of controller 103 and is activated by switch 102, which may be an inertia switch. There is also a primary control resistor 105 and primary gate or primary control transistor 112. A control circuit 106 includes a capacitor 106a and resistor 106b to control the flashing of the LEDs. In this system however, LEDs, such as LEDs 109a and 109b, may be connected to voltage level V2, where V2 may be at 3V or a little less than 3V. Some LEDs, such as 109a, may be connected to both V2 and V3 at different times. Thus, in this example, LED 109a may be connected to both V2, about 3V, and to V3, about 4.5V, at different times, through secondary control transistors or secondary gates 108a and 108b. It will be understood that other voltage levels may be used, and that other components may be used to increase or decrease the voltages available to the LEDs. LED 109a will thus flash more brightly when a higher voltage is applied, such as 4.5V from V3, and will flash less brightly when a lower voltage is applied, such as 3V from V2.

In this embodiment, voltage V2 is also connected to a display of LEDs 113 via control transistors 114. LEDs 113 in the display may be three LEDs in a vertical display or column as previously discussed, or may be arranged in different ways. Control transistors 114 are connected to controller 103 as shown, for control, through outputs 5, 6, and 7 from controller 103. The controller may also enable the flashing of one or more predetermined patterns of lights or LEDs 109a, 109b, and LEDs in the display 113. Random patterns may also be generated and used.

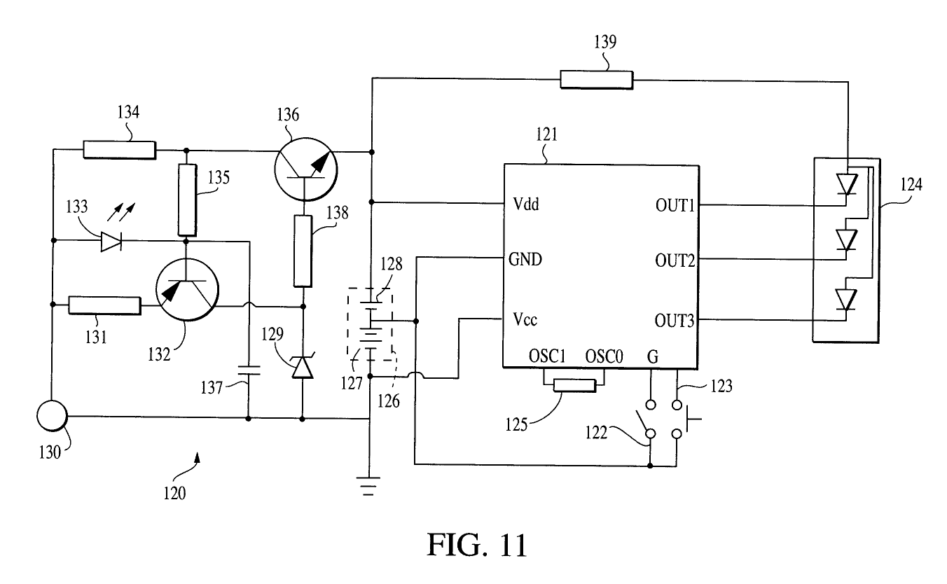

Another embodiment of the invention includes a battery charging circuit 120 along with the flashing light system. FIG. 11 depicts such an embodiment. There is a controller 121, a control resistor 125, a power supply 126 with one or more batteries 127, 128, and switches 122, 123. Switch 122 may be an inertia switch and optional switch 123 may be a toggle switch or other convenient switch, such as a touch switch. The controller routes power through resistor 139 to LED display 124 to flash the LEDs in predetermined patterns. The circuit of controller 121 may route LEDs in the display 124 to one of two different voltages within controller 121, such as 3V and 4.5V through pins OUT1, OUT2, and OUT3, for the LEDs in display 124.

The battery-charging portion of the circuit includes an input jack 130 for inputting suitable recharging power. The recharging voltage should be the sum of one or more batteries 127,128 within the power supply 126. Thus, if batteries 127, 128 are each 3V, then 6V input DC power should be used to recharge the batteries. If the battery has run down, and the base-emitter voltage difference across transistor 136 is greater than about 0.7V when DC power is applied to jack 130, transistor 136 will conduct and will charge batteries 127, 128. The circuit includes a capacitor 137 which charges up, turning on transistor 132 and then transistor 136. The batteries charge, conducting current through LED 133 so that a user may monitor the charging. The process is regulated by resistors 131, 134, 135, and 138, and a Zener diode 129, which controls the desired voltage across the power supply during re-charging. Other recharging circuits may be used instead.

All these and many other circuits may be used in achieving the results of a flashing light system that will flash a letter or message to passers-by. There are many ways to practice the invention. For instance, while LEDs are clearly preferred, other types of lamps may also be used, such as incandescent lamps or other lamps. In other embodiments, flashing light systems according to the present invention may utilize more than one color LED, or may use a different color LED in each display, thus allowing letters of a single color. The displays may use two-color LEDs so that successive letters or successive messages may be displayed in different colors. In another example, it is clear that flashing letters are programmed as predetermined sequences of flashes. These sequences may be alternated with random patterns of flashing to create more interesting visual displays.

It is intended that the foregoing detailed description be regarded as illustrative rather than limiting, and that it be understood that it is the following claims, including all equivalents which define the invention. Any of these improvements may be used in combination with other features, whether or not explicitly described as such. Other embodiments are possible within the scope of this invention and will be apparent to those of ordinary skill in the art. Therefore, the invention is not limited to the specific details, representative embodiments, and illustrated examples in this description.

1. A flashing light system, comprising:
a controller;
a power source connected to the controller;
a switch connected to at least one of the power source and the controller; and
a plurality of lamps connected to the controller, wherein the switch and the controller activate the plurality of lamps to display an alphanumeric character by quickly flashing the lamps in a sequence.

2. The system of claim 1, wherein the plurality of lamps comprises at least three LEDs arranged in a column.

3. The system of claim 1, wherein the switch comprises a motion switch and the controller flashes the lamps in a first sequence when the motion switch closes at a low frequency, and the controller flashes the lamps in a second sequence when the motion switch closes at a higher frequency.

4. The system of claim 3, wherein the low frequency is less than 3 Hz.

5. The system of claim 3, wherein the plurality of lamps comprises a first display and a second display of at least three LEDs each, and the controller flashes the lamps of the first display with a predetermined pattern when the motion switch is closed at a low frequency, and the controller flashes the lamps of the second display with a pattern when the motion switch is closed at a greater frequency.

6. The system of claim 5, wherein the controller is a CMOS controller.

7. The system of claim 1, further comprising a memory of the controller or a memory accessible to the controller, the memory storing data defining at least two patterns at least two patterns of alphanumeric characters, wherein the sequence displayed is responsive to a frequency of the switch closing.

8. The system of claim 7, wherein the patterns of alphanumeric characters comprise a sequential pattern, a forward pattern, a reversed pattern, a random pattern, a fade-in sequential pattern and a fade-out sequential pattern.

9. The system of claim 7, wherein the controller comprises at least two NAND circuits.

10. The system of claim 1, wherein the lamps comprise LEDs in a display, and the LEDs in the display are separated vertically by not more than 2 mm.

11. The flashing light system of claim 1, further comprising footwear into which the system is assembled.

12. The system of claim 1, wherein the power source comprises two batteries and wherein at least one of the plurality of LEDs is connected to two different voltages in the sequence.

13. The system of claim 1, further comprising a second plurality of lamps connected to the power source and the controller.

14. The system of claim 13, further comprising a memory accessible to the controller, the memory storing data defining at least two patterns for flashing the lamps.

15. The system of claim 13, further comprising a plastic display, wherein the second plurality of lamps is embedded in the plastic display.

16. The system of claim 13, wherein the power source comprises two batteries and wherein at least one of the LEDs in the first plurality and the second plurality is connected to two different voltages in sequence.

17. The system of claim 1, further comprising a battery charger.

18. The system of claim 1, further comprising a personal accessory.

19. A method of displaying a message, the method comprising:
wearing an item selected from the group consisting of footwear, an article of clothing, and a personal accessory, the item further comprising the flashing light system of claim 1;
activating the flashing light system; and
displaying the message.

20. A method of displaying a message, the method comprising:
furnishing a flashing light system in footwear, an article of clothing, or a personal accessory, the flashing light system further comprising a controller, a power source connected to the controller, a switch connected to at least one of the power source and the controller, and a plurality of lamps connected to the controller;
activating the flashing light system; and
displaying a message by quickly flashing the lamps in sequence, wherein the lamps flash at least two alphanumeric characters in a sequence to form the message.

21. The method of claim 20, wherein moving the switch is accomplished by one of touching the switch, toggling the switch, and moving the footwear or personal accessory to close an inertia switch.

22. The method of claim 20, wherein the switch is an inertia switch, and a first message is displayed when the inertia switch is closed at a low frequency, and a second message is displayed when the inertia switch is closed at a higher frequency.

23. The method of claim 20, wherein the flashing light system further comprises a second plurality of lamps, and wherein the method further comprises flashing at least one pattern with the second plurality of lamps.

24. A flashing light system, comprising:
a controller;
a power source connected to the controller;
a switch connected to at least one of the power source and the controller;
a first plurality of LEDs connected to the controller, wherein the switch and the controller activate the first plurality of LEDs to display an alphanumeric character by flashing the LEDs in a sequence; and
a second plurality of LEDs connected to the controller, wherein the switch and the controller activate the second plurality of LEDs to display at least one pattern.

25. The system of claim 24, wherein the switch is selected from the group consisting of an inertia switch, a touch switch, and a toggle switch.

26. The system of claim 24, wherein the power source comprises two batteries and wherein at least one of the first and second plurality of LEDs is connected to two different voltages in sequence.

27. The system of claim 24, further comprising a plastic display, wherein the second plurality of LEDs is embedded within the plastic display.

28. The flashing light system of claim 24, further comprising footwear containing the system.

29. The flashing light system of claim 24, further comprising a personal accessory containing the system.

30. A flashing light system, comprising:
a controller;
a power source connected to the controller;
an inertia switch connected to at least one of the power source and the controller; and
a first and a second plurality of lamps connected to the controller, wherein when the inertia switch closes at a low frequency the controller activates the first plurality of lamps, and when the inertia switch closes at a high frequency, the controller activates the second plurality of lamps.

31. The flashing light system of claim 30, wherein, at the low frequency, the controller activates the first plurality of lamps to display at least one alphanumeric character by quickly flashing the lamps in a sequence.

32. The flashing light system of claim 30, wherein, at the higher frequency, the controller activates the second plurality of lamps to display at least one alphanumeric character by quickly flashing the lamps in a sequence.

33. The flashing light system of claim 30, wherein the low frequency is less than 3 Hz.

34. The flashing light system of claim 30, wherein the first plurality and the second plurality each comprise at least three LEDs.

35. The system of claim 30, further comprising a plastic display, wherein the second plurality of LEDs is embedded within the plastic display.

36. The flashing light system of claim 30, further comprising footwear containing the flashing light system.

37. The flashing light system of claim 30, further comprising a personal accessory containing the flashing light system.

38. A flashing light system, comprising:
a controller;
a power source connected to the controller;
an inertia switch connected to at least one of the power source and the controller; and
a plurality of lamps connected to the controller, wherein when the inertia switch closes at a low frequency the controller activates the plurality of lamps to display a first pattern, and when the inertia switch closes at a higher frequency the controller activates the plurality of lamps to display a second pattern.

39. The flashing light system of claim 38, wherein at least one of the first pattern and the second pattern comprises at least one alphanumeric character.

40. The flashing light system of claim 38, wherein the controller comprises at least two NAND circuits.

41. The flashing light system of claim 38, wherein the lamps comprise LEDs in a display, and the LEDs are separated horizontally by about 2-3 mm.

42. The flashing light system of claim 38, further comprising footwear containing the flashing light system.

43. The flashing light system of claim 38, wherein the low frequency is less than 3 Hz.

44. The flashing light system of claim 38, wherein at least one of the first pattern and second pattern is a random pattern.
